(19) United States
(12) Patent Application Publication
(10) Pub. No.: US 2007/0179814 A1
(43) Pub. Date: Aug. 2, 2007

(54) System For Processing Data Representing A Deficiency In A Record

(75) Inventors: Andres Hernandez, Downingtown, PA (US); William D. Lusen, East Norriton, PA (US); Frank W. Racis, Spring City, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, Malvern, PA (US)

(21) Appl. No.: 11/554,638

(22) Filed: Oct. 31, 2006

Related U.S. Application Data
(60) Provisional application No. 60/764,121, filed on Feb. 1, 2006.

(51) Int. Cl. G06F 19/00; G06F 17/00

(52) U.S. Cl. 705/3; 715/530

(57) ABSTRACT

A document deficiency processing system enables a clinician to complete a deficiency by filling and electronically signing a form online using a form template created and associated with a particular document type and automatically initiates sending the filled form to a patient record. A healthcare document processing system for processing a document deficiency preventing a patient record from being designated complete, includes a repository of form information associating an individual form with a document type. A workflow processor automatically employs the repository to identify a particular form, in response to receiving data indicating a document having a particular document type is missing from a record of a particular patient. The workflow processor automatically initiates communication of a message to a user to prompt the user to complete the particular form on-line. An interface initiates communication of data representing the filled in particular form to the record of the particular patient.

This is a non-provisional application of provisional application Ser. No. 60/764,121 by A. Hernandez Feb. 1, 2006.

### FIELD OF THE INVENTION

This invention concerns a system for identifying and managing document deficiencies and form completion in an automated document completion process.

### BACKGROUND INFORMATION

Health information management (HIM) departments in health care provider organizations such as hospitals are responsible for ensuring that patient records are of the highest quality. To ensure the quality of medical records, HIM departments have a process called “record completion”. A record completion process allows a HIM department to implement existing hospital and regulatory policies and regulations regarding completion of medical records. Some of these regulations require that a particular document (e.g., a form) be present in a patient record. In addition the regulations also require that an author sign the document. At the time that the record is being reviewed, the person reviewing the record adds what is called a “deficiency” to the record. A deficiency is an indicator in the record indicating that something is missing, incomplete or incorrect. If the record does not have any deficiencies, it is said that the record is complete. In addition, a record for which deficiencies have been corrected is also said to be complete.

Existing systems indicate the absence of a required form on a patient record but in order to fill in a missing form, a clinician may have to go to a HIM department or to a hospital area where such forms are available. A clinician manually fills in a form and submits it to the HIM department. In the HIM department, a HIM employee looks at the form, determines what patient record to scan the form into, and proceeds to scan the form into the patient's record. This process is lengthy, burdensome and prone to errors. When a record is missing a form, existing systems typically require a clinician to go to a health care organization (either to the HIM department or to the hospital area where such form is available) to be able to manually complete the form. If the health care organization is using an electronic medical record system, a filled in form needs to be manually scanned and filed into an electronic patient record. If the health care organization is not using an electronic medical records system, a filled in form still needs to be filed into a physical paper patient record. In known systems there is typically no way to ensure that when a clinician completes a form that the filled in form is filed correctly in a patient record. A system according to invention principles addresses these deficiencies and related problems

### SUMMARY OF THE INVENTION

A document deficiency processing system employs a deficiency chain in assigning a deficiency to a clinician and enables the clinician to complete the deficiency by filling a form online using a form template created and associated with a particular document type and automatically initiates sending the filled form to a patient record. A healthcare document processing system for processing a document deficiency preventing a patient record from being designated complete, includes a repository of form information associating an individual form with a document type. A workflow processor automatically employs the repository to identify a particular form, in response to receiving data indicating a document having a particular document type is missing from a record of a particular patient. The workflow processor automatically initiates communication of a message to a user to prompt the user to complete the particular form on-line. An interface initiates communication of data representing the filled in particular form to the record of the particular patient.

### BRIEF DESCRIPTION OF THE DRAWING

FIG. 1 shows a document processing system involving online document deficiency completion and management, according to invention principles.

FIG. 2 shows a user interface image menu enabling a user to create a form template, according to invention principles.

FIG. 3 shows a user interface image window illustrating definitional fields that are associated with a form template, according to invention principles.

FIG. 4 illustrates a more detailed image of fields created on a form template by a user, according to invention principles.

FIG. 5 shows a user interface image window illustrating fields of a model deficiency type, according to invention principles.

FIG. 6 shows a user interface image window showing a deficiency chain being defined called “Complete form”, according to invention principles.

FIG. 7 shows a user interface image window showing a deficiency being defined called “Complete form”, according to invention principles.

FIG. 8 shows a user interface image window indicating a short stay history and physical form is missing from a record of patient # 123, according to invention principles.

FIG. 9 shows a user interface image window illustrating a short stay history and physical form to be filled in online, according to invention principles.

FIG. 10 shows a user interface image window indicating a short stay history and physical form was stored in a patient folder, according to invention principles.

### DETAILED DESCRIPTION OF INVENTION

Health information management (HIM) departments in health care provider organizations are responsible for ensuring that patient records are complete. When a HIM department worker, upon analyzing a record, determines that the record is missing a form, the worker adds a deficiency indicator to the record indicating that the form is missing. In a system according to invention principles, the deficiency is assigned to a clinician who is responsible for completing the missing form. If a “form template” is defined for a missing form, the system enables a clinician to fill the form online and automatically file it into a patient record.

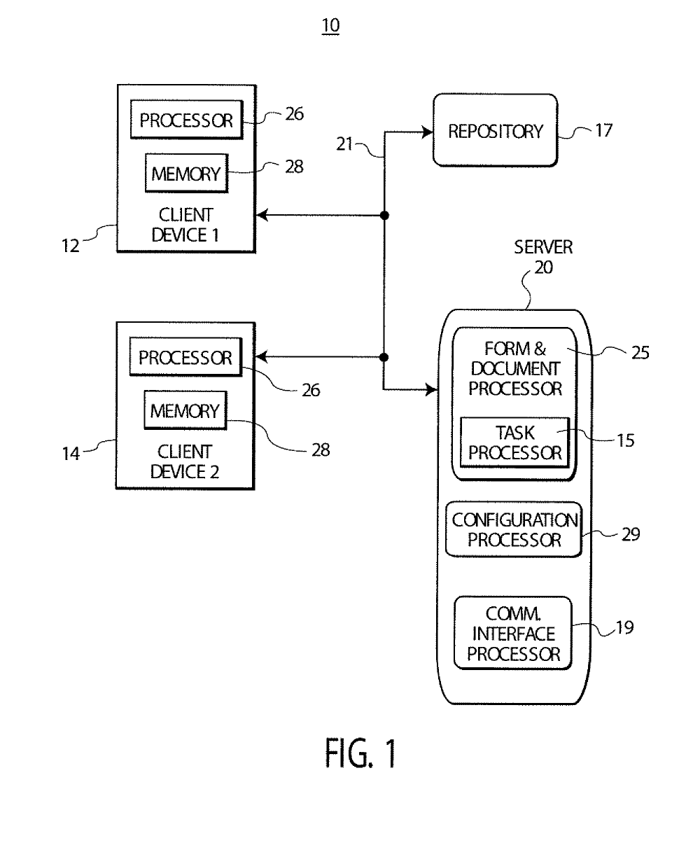

FIG. 1 shows document processing system 10 involving online document deficiency completion and management and employing a form template deficiency completion process enabling HIM department personnel to specify that a given form is not present in a medical record being analyzed. The system enables a user to complete a deficiency by filling and electronically signing (if needed) a form online using a form template created and associated with a given document type. The system creates a deficiency chain to assign a deficiency, indicating a missing form type, to a clinician and advantageously provides a workflow enabling filling a form electronically together with enabling a user to indicate that a medical record is missing a form and automatically initiates sending the filled form to a patient record. The workflow process eliminates the need for a clinician to make a trip to a HIM department or to a hospital area where a clinician manually fills a form and eliminates the need for other personnel to have to scan and file the filled form into a patient record. This reduces sensitivity of a document management system to human errors and enables a clinician to fill needed forms from anywhere where they have access to a HIM application while at the same time reducing the likelihood of errors due to the human handling of the records.

A deficiency indicator identifies that a record is not complete for some reason, such as missing document, missing information on a document, or a required signature is not present in the record. For example, a deficiency indicator is used to indicate that a “history and physical” document is not present in a patient record. After the missing document is acquired into the record, a deficiency can be used to indicate that document needs to be signed by the author. A record may comprise one or more documents and the term “record” may be used interchangeably with the term “document”. An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known user interface element comprising electronic circuitry or software or a combination of both for generating display images or portions thereof. A user interface comprises one or more display images enabling user interaction with a processor or other device. An object or data object as used herein comprises a grouping of data, executable instructions or a combination of both or an executable procedure. A document or record comprises a compilation of data in electronic form and is the equivalent of a paper document and may comprise a single, self-contained unit of information. It may consist of one or more “pages” of information bound together as a unit. The pages may be stored in any digital format as long as the stored pages can be rendered into a human readable presentation.

A form template is a logical grouping of an image (the scanned form) and the fields that can be filled on that form. The fields can be of different types including, text entry fields allowing a user to type text on a form template, static text fields allowing text to be placed anywhere on a form template, Check Boxes allowing a user to fill a check box on a form template and Witness Fields that may be populated with either the logged on user name or initials. The fields can also include an Electronic Signature field allowing a user to electronically sign a document/form, a Capture Signature field allowing a user to sign a document/form by capturing a signature using a signature capture device and date fields allowing a user to populate a field with a date/time, and control how the date/time is displayed. These fields can be populated with the current system date/time as well as other dates from a patient record such as hospital admission date, discharge date, etc. The system automatically populates fields with patient data including text entry, date and witness fields thus reducing the likelihood of data entry errors.

As used herein the term child refers to a folder or document that is contained within another folder. This term reflects the relationship of a folder or document with the folder in which it is contained. The term complete refers to a condition achieved by a folder or document when the information contained therein is verified to be accurate and whole. In the case of a document, this means when there is no missing information relevant and necessary to the document and the contained information is substantially accurate. A folder is complete when expected or required documents exist for that folder and documents contained in the folder are complete. A deficiency refers to some condition that makes a folder or document incomplete. For example, a folder may be missing an expected or required document or a document may be missing information or contain inaccurate information. A deficiency chain refers to an ordered series of data indicating deficiencies used to define a task sequence (a workflow) performed by a worker or system to control a record completion process. A deficiency chain comprises data indicating a sequence of deficiencies of corresponding type that needs to be addressed in order to ensure that a record or document is complete. When a deficiency is created on a record using one of multiple predetermined deficiency chains, a deficiency of a given type is created according to how each of the links in the deficiency chain is defined. A document type (an attribute of a document) is an identifier that is used to group together documents that have the same functional characteristics and allows the logical and physical grouping of documents based on their content. When a form template is created, it is associated with a given document type. When a document is acquired into a HIM system by using a Form template deficiency completion workflow, it is stored in the HIM system as being of the type that is associated with the form template.

Deficiency types allow deficiencies to have a common set of characteristics based on the fact that they are of the same type. In the context of Form Template Deficiency Completion, a deficiency is an indicator that a record is not complete due to a document of a given type not being present in the patient record. In the case that the document not being present in the record is a form, the deficiency indicator is a Form completion indicator indicating the form may advantageously be filled in online. Deficiency indicators also include a Signature deficiency indicator indicating a signature is required, a Miscellaneous Form and document indicator indicating that a document needs to be reviewed, a Form and document indicator indicating that a patient record needs to be analyzed. Document processing system 10 is configurable to perform particular actions based on document type. A Document identifier (document Id) is an internal identifier used to uniquely identify a single document in a document processing system.

A folder is a container used to organize documents. Folders can contain zero or more documents and zero or more subfolders. A folder may be considered a parent of documents and subfolders contained within it. The term incomplete is the antonym of complete. A parent refers to a folder in which another folder or document is contained. This term reflects the relationship of a folder to its contents. The term record is an equivalent term for folder and the two terms may be used interchangeably. Record completion refers to the process required to ensure that a folder or document is complete. A subfolder is a folder that is contained within another folder and is a child of another folder. The invention principles are applicable to any business object (i.e. an object in any industry such as an employee in the human resources industry or an account in the banking industry), but is described for exemplary purposes in the context of business objects of documents and records as defined below.

FIG. 1 shows document processing system 10 including a document deficiency management function. Document processing system 10 includes client devices 12 and 14, repository 17 and server 20. Server 20 includes form and document processor 25 executing a form and document management application, configuration processor 29 executing a configuration application and communication interface 19. Form and document processor 25 includes task processor 15 executing a task processing (workflow) application. The system 10 devices are interconnected and bidirectionally communicate via network 21 such as a LAN (Local Area Network) or other type of network. A client device 12 or 14 includes processor 26 and memory unit 28 and may comprise a personal computer, for example. A user is able create, maintain and manage deficiency chain data using configuration processor 29 via one or more user interface images displayed on client device 12 or 14. The document processing system 10 may be used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Repository 17 (representing one or more distributed repositories) includes chain data identifying, multiple document deficiencies, individual document deficiency type and an order for addressing the document deficiencies for providing completed documents. The document deficiency type and order for addressing the document deficiencies are used by task processor 15 to initiate a method of addressing a deficient condition. Task processor 15 executing a task processing application operating on server 20, uses repository 17 in automatically assigning tasks to be performed by one or more workers in the order for addressing the document deficiencies to correct the deficiencies. A record and the documents contained therein are considered potentially deficient until reviewed by qualified personnel for accuracy and completion. A record or document may be deficient because it is missing vital documents such as an operative report or discharge instructions, it is missing vital information or it contains incorrect information.

Form and document processor 25 automatically completes, creates and assigns deficiencies on documents in response to incorporation of a document into a patient record based on the type of the document and a predefined set of rules. Form and document processor 25 provides a Form Template Deficiency Completion process enabling a user to complete a “Missing form” deficiency by filling a missing form online and storing the form into a record needing the form. Processor 25 supports assignment of a predefined form template or creation of a new form template via a user interface on client device 12 and 14. HIM department personnel employ a deficiency chain in reviewing a form for completeness once a form is acquired into the system.

Form and document processor 25 includes a form template creation interface enabling a user to create a form for use in satisfying a particular document deficiency and associate a created form with a document type. Repository 17 includes form information associating an individual form with a document type. Repository 17 also includes deficiency chain data identifying, multiple document deficiencies, individual document deficiency type, an order for addressing the document deficiencies and a process type to be used in processing an individual deficiency type for providing a completed patient record. The deficiency chain data, indicates how a deficiency is to be corrected and a purpose of an individual deficiency. Task (workflow) processor 15 automatically, employs repository 17 to identify a particular form, in response to receiving data indicating a document having a particular document type is missing from a record of a particular patient.

Task processor 15 determines from the deficiency chain data in repository 17 the data indicating the document having the particular document type is missing from the record of the particular patient. Task processor 15 automatically initiates communication of a message to a user to prompt the user to fill in the particular form on-line. Interface (communication processor interface) 19 initiates communication of data representing the filled in particular form to the record of the particular patient. The data indicating a document having a particular document type is missing comprises deficiency chain data identifying, multiple document deficiencies, individual document deficiency type, an order for addressing the document deficiencies and a process type to be used in processing an individual deficiency type. Task processor 15, in response to the communication of the data representing the filled in particular form to the record of the particular patient, updates the deficiency chain information in repository 17, to indicate, the particular form is filled in and the document having the particular document type is no longer missing from the record of the particular patient. Task processor 15 automatically updates a task list of a user to include a task comprising filling in the particular form on-line and automatically updates a task list of a user to remove a task associated with the particular form in response to a user filling in the particular form. Task processor 15 also automatically populates the particular form with information concerning the particular patient.

System 10 satisfies a medical record deficiency indicating that a form is missing in a patient record by allowing a clinician to fill in a form online. System 10 enables a clinician to fill in a form at any time at any location where there is access to system 10 applications. Configuration processor 29 enables a user to configure a form template to automatically be populated with patient information reducing the burden of data entry and the likelihood of data entry errors. Upon filling of a form, the form is sent to the patient record associated with the corresponding deficiency indicator indicating the form is missing. System 10 removes the missing form deficiency indicator from the patient record in response to the filled in form being incorporated in the patient record.

Form and document processor 25 automatically creates a deficiency indicator indicating a form is missing from a patient record and uses configuration settings for a document type set by a user via display images on client device 12 or 14. Form and document processor 25 supports creation of a form template incorporating fields that a user can populate by data entry online (e.g., via a network or the Internet). A form template may have different field types such as “text entry”, “date”, “static text”, “check boxes”, “witness”, “electronic signature”, and “capture signature” fields. A user is advantageously able to use form and document processor 25 to create a form template via a user interface in client device 12 or 14 to facilitate efficient workflow when completing missing forms for patient records. Patient data related fields are configured to be automatically populated to reduce the data entry burden required by the user to fill the form.

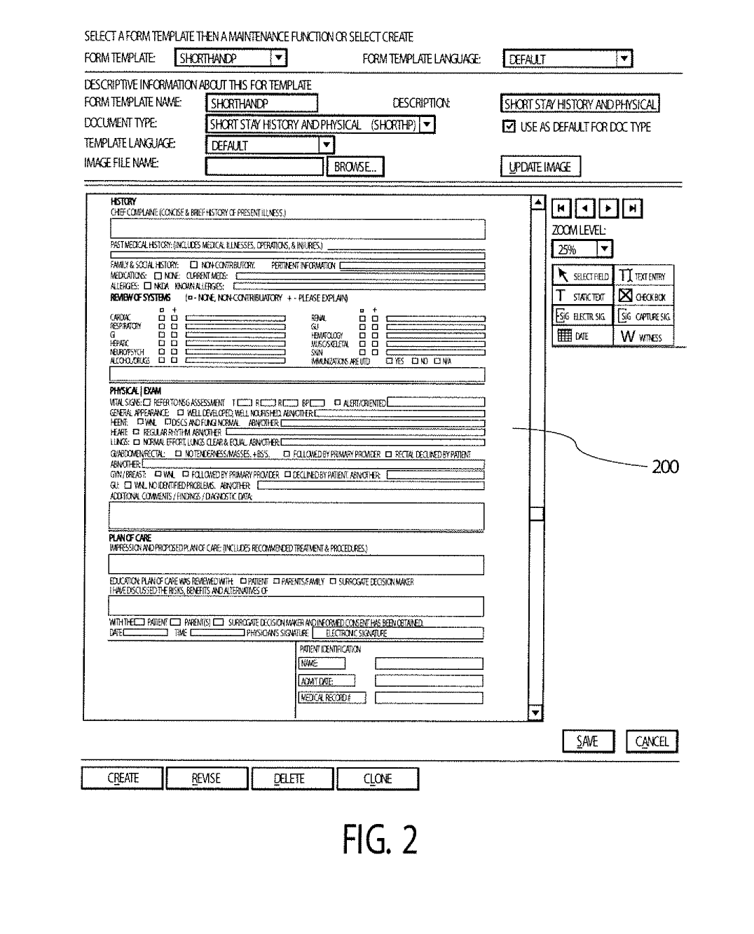

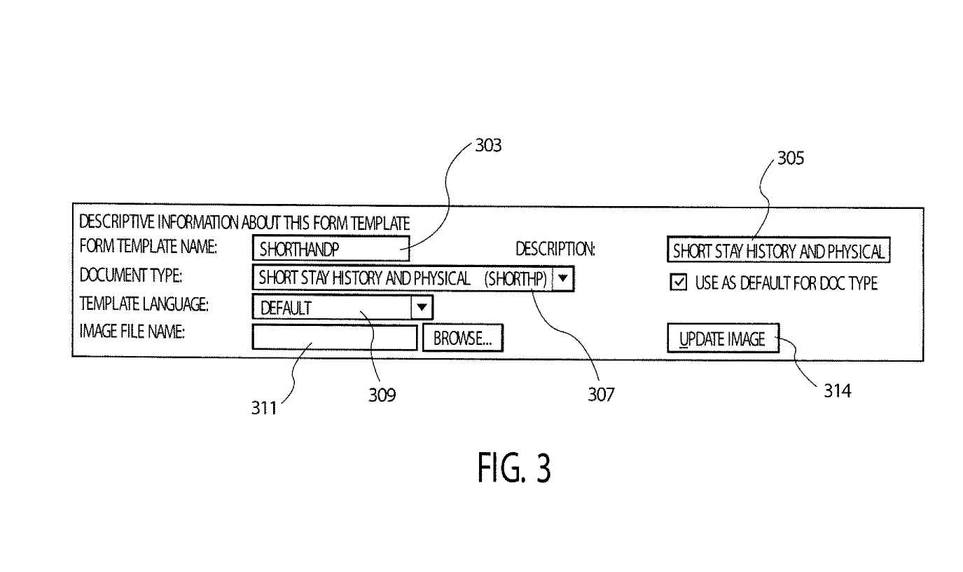

FIG. 2 shows a user interface image menu 200 enabling a user to create a form template. Aspects of this user interface image are presented in subsequent figures. FIG. 3 shows a section of the FIG. 2 form creation image illustrating definitional fields that are associated with a form template including form name field 303 and description field 305 (identifying a short stay history and physical document). Document type 307 is an option list that associates a form template with one of the existing document types in a Clinical information system HIM application. A deficiency is created in a patient record based on document type (independently of form template), for example, a HIM analyst creates a deficiency indicator indicating that a “short stay history and physical” document is missing in a patient record. Template language field 309 is an option list that facilitates creation of form templates in other supported language (e.g., enabling globalization of form creation). Image File Name field 311 enables a creator of a form template to specify a location of an image (scanned image of a paper form to be populated by user data entry) that is to be associated with a form template. Further, update image button 314 displays an image selected by a user in the user interface.

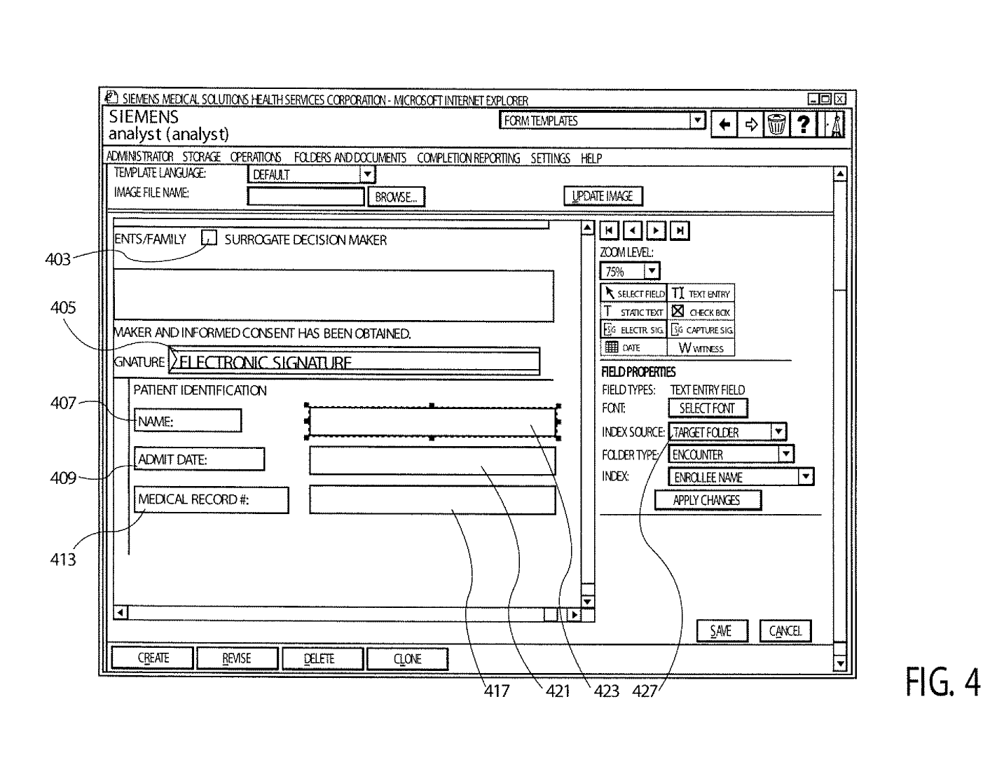

FIG. 4 illustrates a more detailed image of fields created on a form template by a user using system 10. A user employs form and document processor 25 to create a form template including checkbox 403 (for establishing a Surrogate Decision Maker), Electronic Signature 405 (enabling a user to automatically sign the form once the user makes the decision to acquire the form into a Clinical information HIM system) and Static Text labels (Name 407, Admit Date 409, Medical Record # 413 for patient identification). The form template also includes text entry fields 417, 421 and 423 enabling user data entry or for automatic population with patient specific data by processor 25. The field to the left of Name field 407 is selected and index source field 427 is configured to acquire a patient name (enrollee name) from a folder in which the form is filed (Target folder). The automatic form population reduces data entry and associated user burden and errors.

When a document is acquired into a patient record, system 10 automatically completes deficiencies in the record that were created as a result of the document not being in the record and applies remaining deficiencies in a deficiency chain if any, to the document that was just acquired. System 10 uses matching logic based on the type of document being acquired. For instance, if a patient record is deemed incomplete because of absence of a “medical history and physical” document, upon acquisition of a “medical history and physical” document, system 10 completes any applicable deficiencies in the record associated with absence of the “medical history and physical” document. System 10 auto-analyzes documents based on document type. This enables a HIM department to configure a document completion function to perform different actions depending on the type of a given document. For instance, a “medical history and physical” document needs to be present in an inpatient medical record and also needs to be signed by an attending physician, while a “progress notes” document needs to be present in the record, but not signed. System 10 ensures that any “medical history and physical” document in the system gets signed. Deficiency types allow deficiencies to have a common set of characteristics based on the fact that they are of the same type. A deficiency type is composed of attributes including, Name, Description, Icon, Process Type and Age.

A Name attribute is indicative of what is deficient in a record. For instance a Missing Form deficiency indicates that a record is missing a required form in order to be complete. A Description type attribute allows for a more complete description of what the deficiency type is supposed to indicate. For instance, “Waiting for form” is an appropriate description for a “Missing Form.” deficiency type. An Icon attribute is used to provide a visual clue to users of a HIM system that a deficiency of a given type is present by just glancing at the record. A Process Type is a field that tells a HIM system to present a user with an online form for the user to be able to complete the deficiency. The model process type that triggers the system to present the user with a form to be filled in is called “Complete form”. An Age attribute indicates if a deficiency should age or not. This is used to indicate a user, responsible for completing a deficiency, has a given time duration to complete a deficiency. A combination of the above attributes indicates in system 10 how a deficiency that is present in a record or document is to be addressed. The combination of the above attributes tells the system and users of the system how a deficiency that is present in a record or document needs to be addressed. A model deficiency type has deficiency name, description and process type comprising Missing Form, Waiting for Form and Complete Form (which triggers the system form completion workflow), respectively.

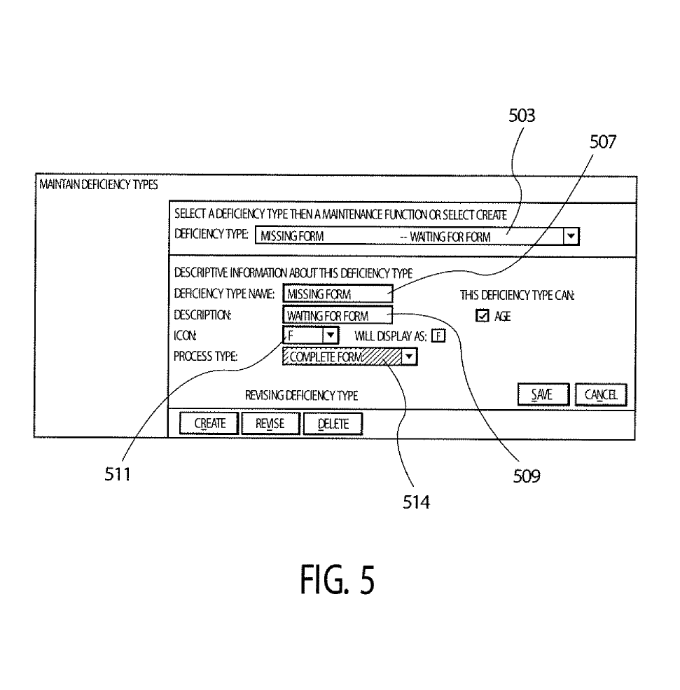

FIG. 5 shows a user interface image window illustrating fields of a model deficiency type having type (Missing Form) 503, name (Missing Form) 507, description (Waiting for form) 509, icon (F) 511 and process type (Complete form) 514. A user of system 10 is able to create a deficiency type having a custom deficiency type that is descriptive of a desired use of the deficiency and enable completion of a form online to address the deficiency by using the “Complete form” process type to trigger special processing that presents the user with a form to be filled in online.

A deficiency chain such as a “Missing Form” chain, in one embodiment, is used to trigger the Form Template Deficiency Completion process. This chain comprises a single link that is satisfied once the form is filled in by a clinician. Another deficiency chain is a “Missing Form->Misc. Analysis” chain composed of two links. The first link (Missing Form) of the chain is completed in response to a clinician completing a missing form. The second link (Misc. Analysis) is used to send the filled in form to a HIM department to process the form and ensure that the form was filled in properly. The deficiency chains employ a “complete form” process type to ensure that task processor 15 in system 10 triggers completion of a form online using a previously predefined form template.

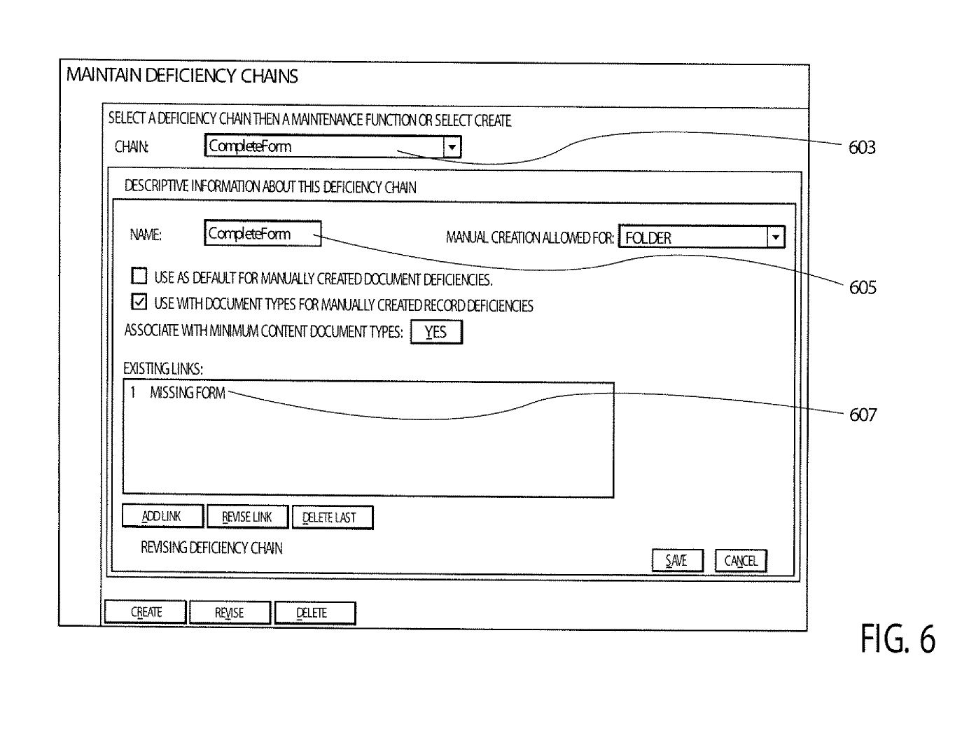

FIG. 6 shows a user interface image window illustrating a deficiency chain being defined called “Complete form” 603, 605 and comprising a single link 607 having a “Missing Form” deficiency type. The deficiency chain may be used to create deficiencies on records that are missing a form. In response to a form being acquired into a patient record, the deficiency is satisfied, and no further processing is required. Because the deficiency chain being defined uses the model type “Missing Form” deficiency system 10 automatically presents the user with an online version of a required form for a clinician to fill in electronically.

A record completion workflow includes a first step involving analyst review of a patient record to ensure that it is complete and a second step involving a clinician reviewing a work list to identify patient records that need to be completed. An analyst ensures that a patient record is complete. In another embodiment this is done automatically using an automated document tracking function employing document identifiers on individual documents and predetermined information indicating documents needed for completion. In the following example, an analyst has determined that the record for patient #123 is missing a short stay history and physical document. As part of implementing a Form Template Deficiency Completion process, a hospital creates a “Form Template” for the short stay history and physical form using the user interface image of FIG. 2.

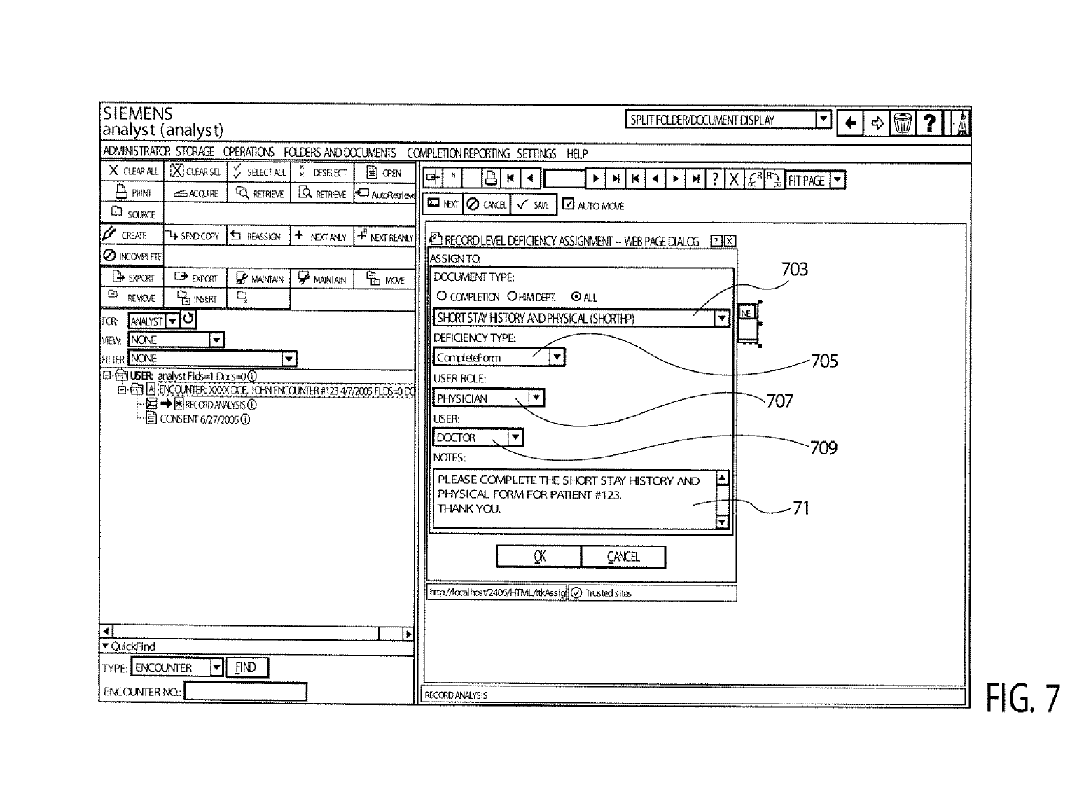

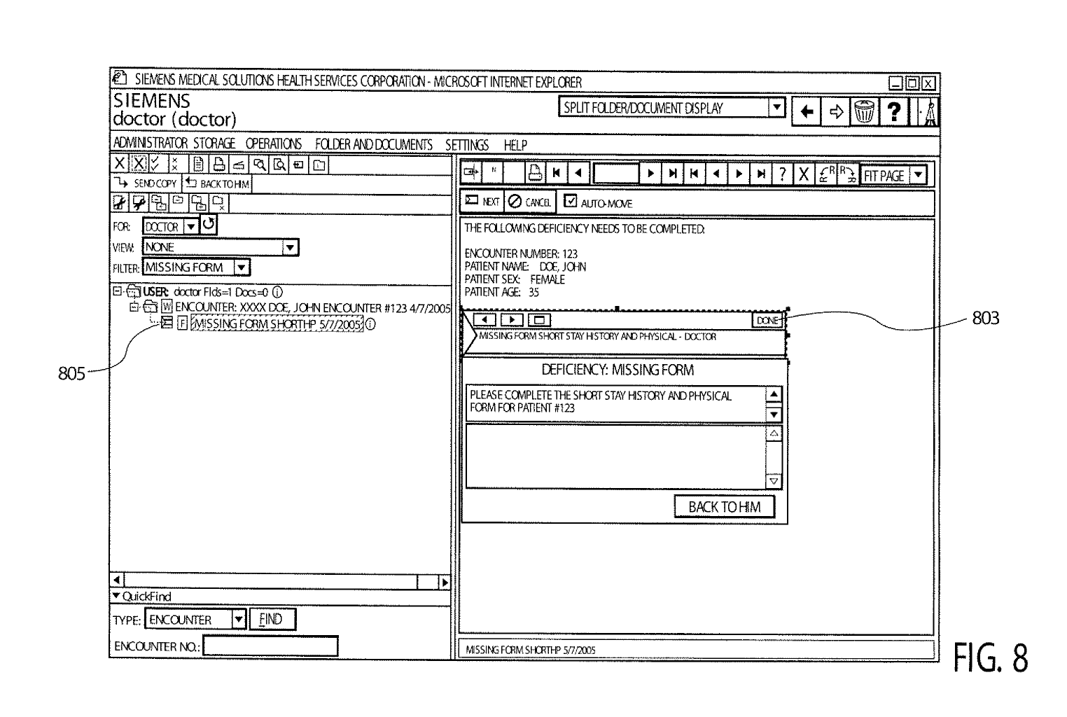

FIG. 7 shows a user interface image window showing a deficiency type 705 being defined called “Complete form” for a short stay history and physical document 703. A doctor 709 having a physician role 707 is requested to complete a short stay history and physical document 703 for patient #123 via message 711. A clinician is responsible for completing his assigned deficiencies and in response to login to system 10, sees that a short stay history and physical form is missing from the record of patient #123. FIG. 8 shows a user interface image window indicating (805) a short stay history and physical form is missing from a record of patient #123. In response to a clinician selecting Done button 803 of the deficiency missing form prompt menu, the clinician is presented with the short stay history and physical form to be filled in online.

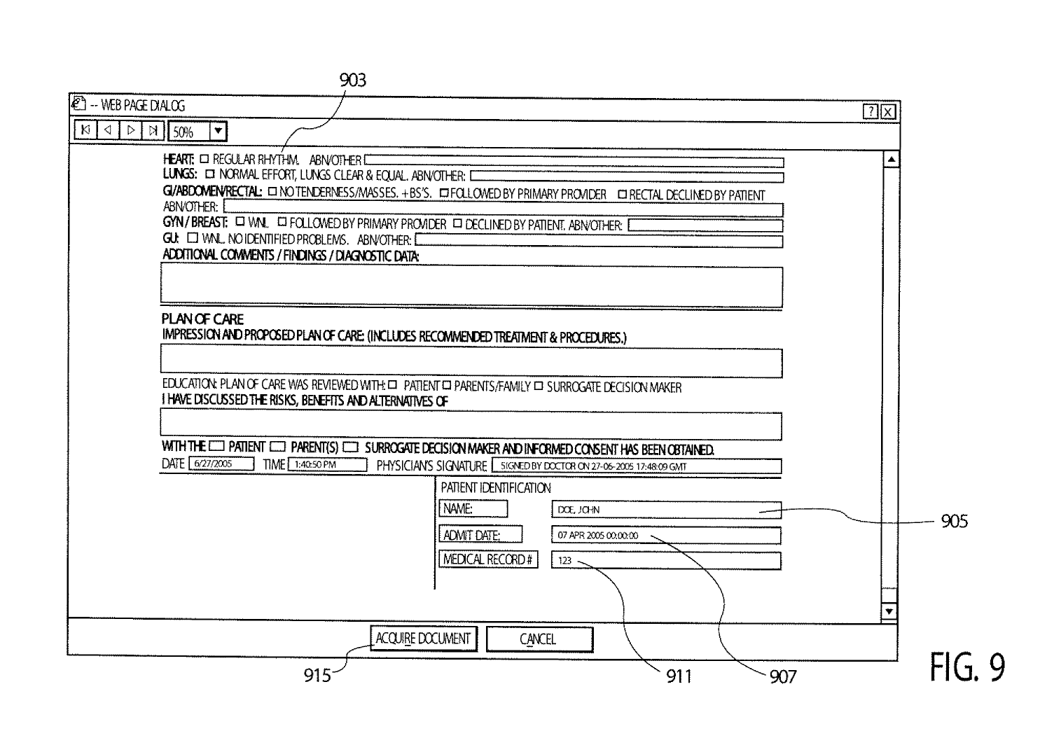

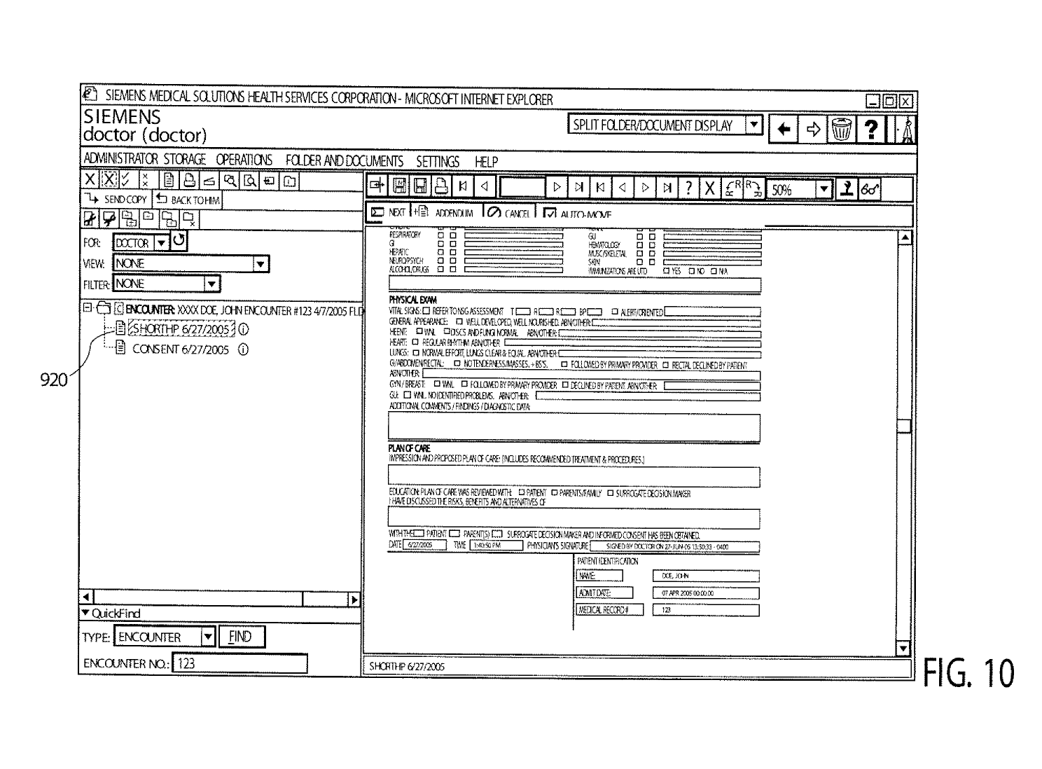

FIG. 9 shows a user interface image window illustrating a short stay history and physical form to be filled in online. A clinician is presented with a form template 903 for the short stay history and physical. Some data fields including patient name 905, admit date 907 and medical record number 911 are advantageously pre-populated with required patient related information thereby reducing data entry burden and accelerating form completion. In response to a clinician finishing filling in the form, the clinician selects “Acquire Document” button 915 and the filled in short stay history and physical form is communicated to the patient record for storage. FIG. 10 shows a user interface image window indicating a short stay history and physical form was stored in a patient folder in item 920. The Form Template Deficiency Completion process advantageously eliminates a need to scan a missing form and expedites the process of completing a patient record.

The Form Template Deficiency Completion process employed by system 10 involves creation of a form template for a health care organization and association of the created form template with a document type. A deficiency chain is created with at least one link e.g., having a “Missing Form” deficiency type. A HIM records analyst makes a determination that a patient record is missing a form and adds a deficiency indicator (using a created deficiency chain) indicating that the form is missing. A clinician, following login to system 10, sees data displayed via client device 12 or 14 indicating the deficiency that was created in a record identifying that a form is missing from the record. In response to the clinician filling in the “Missing Form” online, task processor 15 initiates a Form Template Deficiency Completion process involving automatically communicating the filled in form for storage in a patient record.

System 10 improves workflow in the completion of forms required to be present in a patient record and is usable where workflow requirements require a form to be present in a record. A Human Resources department, for example, can use the Form Template Deficiency Completion process to ensure that employee records have a tax related (e.g., W-4) form in their records.

The systems and image menus of FIGS. 1-10 are not exclusive. Other systems, and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Functions, processes of activities connected with FIG. 1 may be performed automatically or alternatively, wholly or partially in response to manual interaction. A system according to invention principles monitors and processes document deficiencies and automatically manages tasks and creates and provides forms online for addressing and removing document deficiencies. Further, any of the functions and steps provided in the system of FIG. 1 may be implemented in hardware, software or a combination of both and may reside on one or more processing devices located at any location of a network linking the FIG. 1 elements or another linked network including another intra-net or the Internet.

What is claimed is:

1. A healthcare document processing system for processing a document deficiency preventing a patient record from being designated complete, comprising:
a repository of form information associating an individual form with a document type;
a workflow processor for automatically,
employing said repository to identify a particular form, in response to receiving data indicating a document having a particular document type is missing from a record of a particular patient and
initiating communication of a message to a user to prompt said user to fill in said particular form online; and
an interface for initiating communication of data representing said filled in particular form to said record of said particular patient.

2. A system according to claim 1, including
a repository including deficiency chain data identifying, a plurality of document deficiencies, individual document deficiency type, an order for addressing said document deficiencies and a process type to be used in processing an individual deficiency type for providing a completed patient record wherein
said workflow processor determines from said deficiency chain data repository said data indicating said document having said particular document type is missing from said record of said particular patient.

3. A system according to claim 2, wherein
said workflow processor in response to said communication of said data representing said filled in particular form to said record of said particular patient, updates said deficiency chain information in said repository, to indicate at least one of, (a) said particular form is filled in and (b) said document having said particular document type is no longer missing from said record of said particular patient.

4. A system according to claim 2, wherein
said repository including deficiency chain data, indicates at least one of, (a) how a deficiency is to be corrected and (b) a purpose of an individual deficiency.

5. A healthcare document processing system for processing a document deficiency preventing a patient record from being designated complete, comprising:
a form template creation interface enabling a user to create a form for use in satisfying a particular document deficiency and associate a created form with a document type;
a repository of form information associating an individual form with a document type; and
a workflow processor for automatically,
employing said repository to identify a particular form, in response to receiving data indicating a document having a particular document type is missing from a record of a particular patient and
initiating communication of a message to a user to prompt said user to fill in said particular form on-line.

6. A system according to claim 5, wherein
an interface for initiating communication of data representing said filled in particular form to said record of said particular patient.

7. A system according to claim 5, wherein
said data indicating a document having a particular document type is missing comprises deficiency chain data identifying, a plurality of document deficiencies, individual document deficiency type, an order for addressing said document deficiencies and a process type to be used in processing an individual deficiency type.

8. A system according to claim 5, wherein
said workflow processor automatically updates a task list of a user to include a task comprising filling in said particular form on-line.

9. A system according to claim 5, wherein
said workflow processor automatically updates a task list of a user to remove a task associated with said particular form in response to a user filling in said particular form.

10. A system according to claim 5, including
an interface for automatically initiating communication of data representing said filled in particular form to said record of said particular patient.

11. A system according to claim 5, including
a workflow processor for automatically populating said particular form with information concerning said particular patient.

12. A healthcare document processing system for processing a document deficiency preventing a patient record from being designated complete, comprising:
a form template creation interface enabling a user to create a form for use in satisfying a particular document deficiency and associate a created form with a document type;
a repository of form information associating an individual form with a document type; and
a workflow processor for automatically,
employing said repository to identify a particular form, in response to receiving data indicating a document having a particular document type is missing from a record of a particular patient and
initiating communication of a message to a user to prompt said user to fill in said particular form on-line.
